(19) United States
(12) Patent Application Publication
(10) Pub. No.: US 2026/0344680 A1
(43) Pub. Date: Nov. 5, 2026

(54) BIOCONTROL PRODUCT USING A CO-PRODUCT OF LEEK

(71) Applicant: INSTITUT SUPERIEUR DES BIOTECHNOLOGIES (SUPBIOTECH), VILLEJUIF (FR)

(72) Inventors: Agnès SAINT-POL, VILLEJUIF (FR); Patrick GONZALEZ, VILLEJUIF (FR); Valentina GLIGORIJEVIC, VILLEJUIF (FR)

(73) Assignee: INSTITUT SUPERIEUR DES BIOTECHNOLOGIES (SUPBIOTECH), VILLEJUIF (FR)

(21) Appl. No.: 19/102,884

(22) PCT Filed: Aug. 12, 2022
(86) PCT No.: PCT/FR2022/051581

§ 371 Date: Feb. 11, 2025

(51) Int. Cl. A01N 65/40; A01N 25/12; A01N 59/20

(52) U.S. Cl. CPC A01N 65/40; A01N 25/12; A01N 59/20

(57) ABSTRACT

The present invention proposes a biocontrol product comprising or consisting of a leek powder having a particle size of less than 700 um. The leek used in the biocontrol product is derived from the co-product of the harvesting of leek and exhibits a very high antifungal activity when it is brought into contact with an agricultural product to be protected, such as a seed, a crop or a fruit that has been harvested. The invention also relates to aqueous extract obtained from the biocontrol product of the invention and to an optimised method for obtaining said biocontrol product. Finally, the invention also proposes the combined use of a biocontrol agent, such as copper salts, lipopeptides and detergents, with the biocontrol product of the invention and in order to obtain an antifungal synergistic effect.

### FIELD OF INVENTION

The invention relates to the field of biocontrol molecules and the recovery of agricultural waste. The invention relates in particular to the recovery of the co-product of leek as a biocontrol product, and the method for obtaining same.

### State of the Art

The cultivation of cereals, fruits and vegetables is subject to attacks by pests (insects, weeds, microorganisms, etc.) which affect crop yields and thus reducegrower' profits. In order to overcome these disadvantages, farmers regularly, if not massively, use pesticides to protect crops and thus increase their yields. However, the use of pesticides is not without risks to the health or sustainability of cultivated soils. In addition, they also lack selectivity; pests are certainly destroyed effectively, but other species of insects or microorganisms useful to plants can be affected. It should be noted that since their use, certain pesticides are now banned from sale.

To overcome the disadvantages of pesticides, farmers have looked for alternatives and turned to products called biocontrol products, which are more selective and less toxic to the environment. Most often, these are natural products present in plants or microorganisms; in application WO2022047396, it is demonstrated that microbial compositions have beneficial effects on the agricultural level. Although effective, the production of natural products by microorganisms remains low and the amounts that crops need to be protected may not be sufficient.

In application WO2021236799 reference is made to a biological control composition based on an intact minicell containing a nucleic acid that targets a transcription product encoding a polypeptide and a method for controlling pests and pathogens with novel systems and compositions for administering RNA molecules within crops. Here again, the use of an intact minicell, although effective, may encounter concerns about stability of use within soils.

Thus there is a clear need for an alternative to pesticides and biocontrol products are one of these alternatives that solve the disadvantages of said pesticides. However, the amount of biocontrol agents obtained and their stability remains a problem that must be resolved in order to make a daily use thereof that positively impacts crop yields while preserving them and the environment.

In particular, there is a need for effective biocontrol agents to deal with fungal diseases involved in many plant diseases, and causing significant production losses. For example, diseases such as gray mold, alternaria, and fusarium affect different plant productions, from seed to post-harvest product.

Plant extracts can at least partially meet these needs. For example, the allium family, and in particular garlic, has been known for many years for its antibacterial effects, as well as its antifungal and insecticidal activity. Its effectiveness having been widely demonstrated, garlic extract is now recognized in France in the list of biocontrol plant protection products, under Article L. 253-5 and L. 253-7 of the Rural and Maritime Fishing Code. Garlic extract is marketed in concentrations of 45% w/w as a biocontrol product.

However, it remains desirable to have other biocontrol products that can effectively combat fungal diseases and molds at different stages of agricultural production. It is also desirable to have new biocontrol agents that are accessible in large volumes, at low cost, and without monopolizing agricultural land for their production.

### SUMMARY OF THE INVENTION

A purpose of the invention is therefore to propose a new biocontrol product effective against fungal diseases, which can be produced in large volumes and at a moderate price.

For this purpose, the invention provides a biocontrol product comprising or consisting of a leek powder (Allium porrum) whose average particle size is equal to or less than 700 μm, and preferably comprised between 10 μm and 700 μm. The average particle size of the powder may also be from 90 to 500 μm, from 90 μm to 300 μm, or preferably 90 μm to 180 μm. In one embodiment, the particle size is comprised between 90 and 700 μm.

Indeed, it is to the inventors' credit to have demonstrated that dried leek in powder form with a particle size≤700 μm has antifungal properties against a significant spectrum of pathogenic molds and their spores. Surprisingly, the inventors found that at the same dose of leek powder tested, a particle size greater than 700 μm greatly limits the antifungal activity and does not prevent the growth of molds.

The antifungal effect can be obtained by using the leek powder brought into direct contact with an agricultural product to be protected, such as a seed, a crop or a fruit that has been harvested. The leek powder according to the invention therefore constitutes a biocontrol product in itself, or it can be incorporated into a formulation comprising excipients, preservatives and/or other active ingredients, or be used in the form of an extract.

The biocontrol product according to the invention is derived from the upper part and/or the lower part of the leek. The upper part corresponds to the leaves of the green part of the leek and the lower part corresponds to the leaves of the white part of the leek typically used as food.

Advantageously, the biocontrol product of the invention is derived from the co-product of the harvesting of leek, and is composed essentially, mainly or exclusively of the green part. It will thus be possible to recover a plant waste whose source is sustainable and abundant. Indeed, the annual production of leeks in France is approximately 165000 tons and it is estimated that 15% or 20% of the production is lost as a co-product resulting from post-harvest peeling. The present invention therefore allows to recover as a biocontrol product this part of the harvesting of leek which is currently unexploited.

In order to facilitate the application of the biocontrol product, the invention proposes to produce an aqueous extract from the leek powder described above. Advantageously, a simple aqueous extract has a high antifungal activity when it is brought into contact with the product to be treated. Moreover, unlike garlic extracts, the aqueous extract of the invention does not have an antifungal activity when it is at a distance from the product to be treated.

In one embodiment, the invention provides an aqueous extract having a concentration of leek powder per volume of solvent comprised between 5 g/L and 50 g/L, preferably 10 g/L to 25 g/L. In particular, a concentration comprised between 10 g and 50 g of leek powder per 1 L of water allows to extract approximately 60 to 90% of the antifungal activity of the powder. The extract may be used with the leek powder suspended in water or as a filtrate in order to facilitate the use of the extract.

The pH of the simple aqueous extract is comprised between 6 and 7 without pH adjustment, in particular between 6.5 and 6.8 and has an antifungal activity. Preferably, the pH of the extract is comprised between 3.5 and 5.5, and preferably between 3.7 and 4.7. The antifungal activity can thus be significantly increased. Advantageously, the extract comprises an organic acid, such as acetic acid, to acidify the pH and further improve the antifungal activity.

The invention also relates to a biocontrol, insecticide or antifungal composition comprising a biocontrol product according to the invention or an aqueous extract of said biocontrol product.

Advantageously, the inventors have demonstrated the synergistic effect of leek powder or its extract according to the invention with other biocontrol agents, such as copper salts, cationic and anionic detergents, lipopeptides and acetic acid. The invention therefore provides a composition comprising a biocontrol product according to the invention or an aqueous extract of said biocontrol product and also comprising one of the following compounds or any combination of these compounds:
a copper salt selected from copper sulfate, cuprous oxide, copper hydroxide, copper oxychloride, tribasic copper sulfate, copper acetate, copper tallate and expanded copper carbonate or mixtures thereof, and allowing to consider a reduction by at least 2 in the amounts conventionally used in the treatment of crops with copper;
an antiseptic or disinfectant surfactant, preferably an anionic surfactant compound, for example sodium lauryl sulfate, and/or a cationic surfactant, for example cetrimonium bromide, and allowing to consider a reduction by at least 5 in the use of co-product of leek biomass and by 2 the required amount of detergent;
a lipopeptide-type compound having antimicrobial properties, preferably antifungal activity, for example caspofungin, or surfactins, iturins, and fengycins produced by different strains of Bacillus sp, and allowing to consider a reduction by at least 5 times the use of co-product of leek biomass while reducing by at least 2 times the required concentrations of lipopeptides to achieve an antifungal effect.
an organic acid selected from acetic acid, propionic acid or mixtures thereof and allowing to consider a reduction by at least 5 times the use of co-product of leek biomass while reducing by at least 2 times the concentrations required to achieve an antifungal effect.

Of course, the invention also relates to the combined use of the biocontrol product of the invention or of the aqueous extract of the invention with one of the compounds mentioned above and mixtures thereof, in particular when they are applied as an antifungal treatment on crops, seeds and/or plants.

Due to the synergistic effect of the biocontrol product of the invention with other biocontrol products, the respective concentration of the copper salt, the antiseptic surfactant and/or the lipopeptide compound present in the composition is lower than the active dose required for the use alone of said compounds as biocontrol products.

Effective antifungal concentrations can therefore be considered from 0.5% to 5% m/V (5 to 50 g/L if V=1 L), preferably 1% to 2.5% (10 g/L to 25 g/L if V=1 L) for the leek green powder according to the invention or the aqueous extract resulting from said concentration. The leek powder can also be combined with surfactant compounds such as lauryl sodium sulfate in an amount comprised between 0.01% and 0.1% of the mass of leek powder comprised in the biocontrol composition. The leek powder may also be combined with fungicidal compounds such as copper salts which may be present in an amount comprised between 5% and 20% of the mass of leek powder comprised in the biocontrol composition. The leek powder may also be combined with a mixture of fungicides and surfactants at the above-mentioned concentrations.

Empirically, the combined use of the extract of the invention with a copper salt on a crop allows to apply a dose of copper of less than 4 kg/ha/year (dose authorized per year as recommended by the European Commission), and preferably less than 3 kg/ha/year or 2 kg/ha/year. The dose per application of copper salt may of course also be reduced by at least a factor of 2.

In preferred embodiments, the composition or use includes one of the following combinations:
an aqueous extract according to the invention, copper sulfate and a surfactant selected from sodium lauryl sulfate and cetrimonium bromide;
an aqueous extract according to the invention, sodium lauryl sulfate, and a lipopeptide selected from iturin, surfactin, fengycin or mixtures thereof.

The composition of the invention is in liquid form, perhaps presented in the form of a powder to be incorporated into an aqueous solvent before its use, or in the form of a kit comprising the different biocontrol agents to be mixed and dissolved in water in a predefined order for its use. The invention provides the use of a biocontrol product according to the invention, an extract from a biocontrol product according to the invention and/or the composition according to the invention for biocontrol, insecticide or antifungal purposes. In particular, the invention provides said use on seeds, crops or plants such as post-harvest fruits or vegetables.

The invention also relates to a seed coated by film coating or spraying with a biocontrol product, an extract or a composition according to the invention.

The invention also relates to a method for obtaining a biocontrol product according to the invention, said method comprising the following steps:
1) Harvesting the green or green and white parts of the leek;
2) Cutting the parts according to 1);
3) Drying said parts of the leek;
4) Grinding the parts after drying to obtain an average particle size ≤700 μm, and preferably comprised between 10 μm and 700 μm, preferably 90 μm and 500 μm, even more preferably 90 μm and 180 μm.
5) Optionally sieving the extract obtained in step 4.

Advantageously, the invention proposes to optimize the drying step of obtaining said extract by one or all the following actions:
cutting into sections or strips the green or green and white parts of the leek before the drying step 2). Preferably the sections are about 1 to 5 cm, and the strips 0.5 cm by 2 cm. On the contrary, a loss of activity is observed when the leek parts are directly dried.
the drying step 2) is carried out at a temperature below 70 °C, preferably below 60 °C and more preferably at a temperature comprised between 30 and 50 °C or between 30 and 40 °C. On the contrary, a loss of activity is observed with a drying temperature above 70 °C.
the drying step 2) is carried out for a drying duration varying from approximately 24 hours to 72 hours, using a ventilated dehydrator. Advantageously, the drying step can thus be carried out with a means available on farms, and so as to maintain optimal activity of the biocontrol product of the invention.
the drying step 2) is carried out until a moisture content of around 5% (±1% or 2%) is obtained and so as to stabilize the components having antimicrobial activity in the biocontrol product of the invention.

The method of the invention includes an aqueous extraction step in order to obtain the aqueous extract of the leek powder of the invention. Preferably, the duration of the extraction step is less than 60 minutes, and preferably is comprised between 2 and 30 minutes.

Optionally, the method also includes a step of adjusting the pH between 3.5 and 5.5, preferably 3.7 to 4.7 by adding an organic acid such as acetic acid.

Optionally, the method includes a filtration step to collect a filtrate of said extraction and thus facilitate the use of the extract. The unfiltered extract may also be used with the suspended powder.

### DEFINITIONS

In the present invention, powder means a form of matter consisting of more or less fine dry solid particles, in a free or agglomerated state.

White or lower part of the leek, or white of the leek, means the white leaves of Allium porrum also known as Allium ampeloprasum var. porrum.

Green or upper part of the leek, or green of the leek, means the green leaves of Allium porrum also known as Allium ampeloprasum var. porrum.

In the figures, treatment means the use of leek powder or the aqueous extract according to the invention.

Aqueous extract means the liquid of a maceration of leek powder in water, possibly filtered, and its concentration is expressed as the amount of leek powder per volume of solvent used in said maceration, and before filtration. In the experimental part, the aqueous extract is obtained from leek green powder without this being limiting for the invention.

### FIGURES

FIG. 1 Antifungal activity of leek green powder according to the invention on common phytopathogens.

FIG. 2 Impact of particle size on antifungal activity. Particle sizes greater than 700 μm (A), comprised between 180 and 700 um (B), 90 and 180 um (C) and less than 90 um (D).

FIG. 3 (A) Sporicidal and fungicidal effect of leek extract on Alternaria. (B) Antifungal efficiency as a function of the growth stage.

FIG. 4 Post-harvest treatment of infected fruits. (A) Treatment of clementines with leek green powder, (B) treatment of clementines with aqueous extract, and (C) treatment of tomatoes with aqueous extract.

FIG. 5 Treatment of broccoli seeds with an aqueous extract of leek green. (A) Broccoli seeds were infected with spores of Alternaria alternata or Botrytis cinera then treated with leek green extract before germination and growth for 7 days. (B) Measurement of seedlings at 7 days

FIG. 6 Antifungal activity of the aqueous extract in combination with a detergent. (A) Extract+anionic detergent, sodium lauryl sulfate, (B) Extract 50 g/L diluted by 5 or 10+cationic detergent CTAB. The wells were inoculated with a strain of A. Alternata for incubation at room temperature for 5 days.

FIG. 7 Antifungal activity of the aqueous extract in combination with a biocontrol product. (A) Extract+copper sulfate, (B) Extract 50 g/L diluted by 5 or 10+a lipopeptide, surfactin (Bacillus Subtilis). The wells were inoculated with a strain of A. Alternata for incubation at room temperature for 4 to 6 days.

FIG. 8 Impact of pH on the antifungal activity of the aqueous extract. (A) Effect of pH of the culture medium. (B) Antifungal activity of the aqueous extract prepared in water with 2 mM acetic acid (0.012%).

FIG. 9 Combined antifungal effects of aqueous extract with detergent (0.01% lauryl sulfate) and copper sulfate. Initial concentration of extract 50 g/L. Wells were inoculated with a strain of A. Alternata for incubation at room temperature for 3 days.

FIG. 10 Combined antifungal effects of the aqueous extract with a detergent (lauryl sulfate 0.01%) and a lipopeptide (fengycin 50 mg/mL). Initial concentration of the 50 g/L. The wells were inoculated with a strain of A. Alternata for incubation at room temperature. (A) Observation by microscopy after 20 hours of treatment, (B) Macroscopic observations after 6 days of treatment.

FIG. 11 Combined antifungal effects of the aqueous extract with a detergent (lauryl sulfate 0.01%) and a lipopeptide (Iturin A 25 μg/ml). Initial concentration of the extract 50 g/L. The wells were inoculated with a strain of A. Alternata for incubation at room temperature for 24 hours, followed by observation by microscopy.

FIG. 12 Impact of the transformation method on antifungal activity. (A) Impact of the cutting method on antifungal activity. Leek leaves are cut by the indicated approaches, then subjected to the following steps of the method (drying at 40 °C, grinding and extraction). The growth of Alternaria is evaluated by crystal violet quantification after incubation for 4 h 30 to 5 h in the presence of extract (3.125 to 50%) in the culture medium then compared to the negative control. (B) Impact of the drying temperature on antifungal activity. Leek leaves are cut into sections then dried at different temperatures before being subjected to the following steps of the method. The growth of Alternaria is evaluated by crystal violet quantification.

FIG. 13 Impact of powder concentration (10, 20 and 50 g/L) during maceration on the extraction efficiency of antifungal activity. Antifungal activity is quantified by measuring the radial growth of a Trichoderma strain after incorporation of leek powder into a nutrient agar medium. The residual activity after extraction is compared to the initial activity to deduce the percentage of activity extracted.

FIG. 14 A and 14B Impact of maceration duration on the level of extraction of antifungal activity. (A) Quantification by growth measurement after crystal violet staining.

(B) Germination of Alternaria in the presence of 12.5% extract obtained after maceration of 2 (panel B), 30 (panel C), 60 (panel D) and 120 (panel E) min.

### DETAILED DESCRIPTION OF THE INVENTION

The purpose of present invention is to enhance the value of market garden co-products, in particular leeks as a biocontrol product. In particular, the purpose of the invention is to propose a form of leek ensuring the achievement of biocontrol effects, as well as to propose forms of leek preparation allowing to obtain said effect and facilitating its application on plant products such as crops, seeds and harvests.

For these purposes, the invention proposes a biocontrol product comprising or consisting of a leek powder having a particle size of less than 700 μm. Indeed, the inventors have found that the use of leek powder with such a particle size allows to obtain antifungal effects against a broad spectrum of phytopathogenic molds. The leek powder of the invention can therefore be used directly as a biocontrol product by sprinkling or spraying a product to be protected. Biocontrol product means a product of biological origin used as a treatment in the protection of plants against diseases of microbial origin and insects.

In particular, the invention proposes to valorize the green part of the leek because it is a co-product of the harvesting of leek. The white part of the leek is also active and can be used for the purposes of the invention, it will have the advantage of having a higher activity than the green part. Indeed, the leek white powder has an antifungal activity of approximately 5 to 10 times higher than the leek green powder (results not presented). A mixture of white and green parts of leek can therefore be considered, and the ratio will depend on the percentage of each part in the co-product to be valorized. The experimental results presented below are based exclusively on the leek green powder.

In order to facilitate the use of leek, the invention proposes to produce an aqueous extract of the leek powder according to the invention. Surprisingly, a simple aqueous maceration allows to obtain an extract having a high antifungal efficiency, and does not require the use of particular co-solvents or a pH adjustment step. The extract of the invention can therefore be obtained very easily, and with basic equipment available on farms. The leek green extract is active from concentrations of 5 g/L and will preferably be used at a concentration of 10 g/L to 25 g/L. A concentrated leek green extract of approximately 50 g/L can also be considered to be diluted before its use as a treatment on plant products. In order to optimize the activity of the extract, it is suggested to adjust its pH between 3.5 and 5.5, preferably using an organic acid such as acetic acid.

The inventors have also demonstrated the synergistic effect of the combination of the leek powder according to the invention and other control agents whose doses used are to be reduced for environmental reasons. In particular, synergy has been found with copper salts, detergents and lipopeptides having antimicrobial activity. The invention thus allows to significantly reduce the doses used of said agents when they are combined with the antifungal effects of the leek powder or its extract.

The invention also relates to the optimization of the method for obtaining the leek powder and the aqueous extract of the invention. As already mentioned, the particle size ≤700 μm is essential to obtain an effective antifungal effect with a low dose of leek powder. On the other hand, the use of a powder, that is to say a form of the particles in the dry state, necessarily involves the drying of the fresh form of the leek before or after its grinding.

Drying the leek is indeed a step in the method for obtaining the biocontrol product according to the invention. The inventors have highlighted the importance of this drying step in stabilizing the antifungal activity. Consequently, the invention proposes the use of leek in powder form as a biocontrol product and an extract obtained from this powder.

The invention proposes in particular a method for obtaining the biocontrol product comprising or consisting of a leek powder with a particle size ≤700 μm. This method proposes to optimize the drying step to maintain the highest possible activity. The drying step can in particular be optimized by the prior cutting into sections or strips of the fresh parts of the leek, and the drying of said pre-cut parts to approximately 5% humidity, the use of temperatures below 70 °C, and by a duration of 24 to 72 hours. The grinding is then carried out so as to obtain the desired particle size. To prepare the extract, it will be enough to carry out an aqueous maceration at room temperature for a duration of 2 to 30 minutes of the leek powder thus obtained. The extract can be used with the powder in suspension or be filtered to facilitate its use.

The following experimental part demonstrates the many advantages of valorizing the co-product of leek when it is put in the form of powder and a specific particle size, or an extract obtained from this powder. The potential as a biocontrol product has been highlighted by means of the antifungal activity, but a use as an insecticide is also considered.

### EXPERIMENTAL PART

### I. Transformation of Leeks

### 1.1 Obtaining Leek Powder

The green leek leaves are separated and washed before being dried at a low or medium temperature. The drying will be done in such a way as to preserve the activity of the molecules sensitive to its degradation and the conditions will vary depending on the drying method chosen. According to a non-limiting embodiment, the drying step is carried out using a ventilated dehydrator allowing gradual drying of the leek leaves in less than 72 hours, at a temperature below 70 °C and until a preferred humidity level of around 5% is obtained.

The leek leaves are then roughly crushed then ground indifferently using a hammer mill or a blade mill until reduced to powder form. Preferably, this grinding is carried out in cycles (generally 3 times 15 sec) with a short rest period to limit the heating of the powder and up to a particle size of less than 700 μm. The objective here is to reduce the size of the biomass in order to increase the contact surface with the environment and to achieve an optimal level of extraction of active ingredients, that is to say diffusion of active ingredients from the powder to the product to be treated, while retaining the activity of the active ingredients.

In order to optimize the drying step and the preservation of the active molecules, the invention proposes to cut the leek parts into sections of approximately 1 to 5 cm or into strips of approximately 0.5 to 2 cm wide to guarantee optimal antifungal activity. This cutting step allows for faster drying at low temperature and leads to stabilization of the active forms. The strips or sections are then dried for 24 to 72 hours in a ventilated dehydrator at a temperature below 70 °C and ideally between 30 and 50 °C. In the context of the present invention, it is not recommended to grind the fresh parts also called “fresh grinding” of the leek parts because in this case the antifungal activity decreases more than significantly, or even risks disappearing.

### 1.2 Aqueous Extract

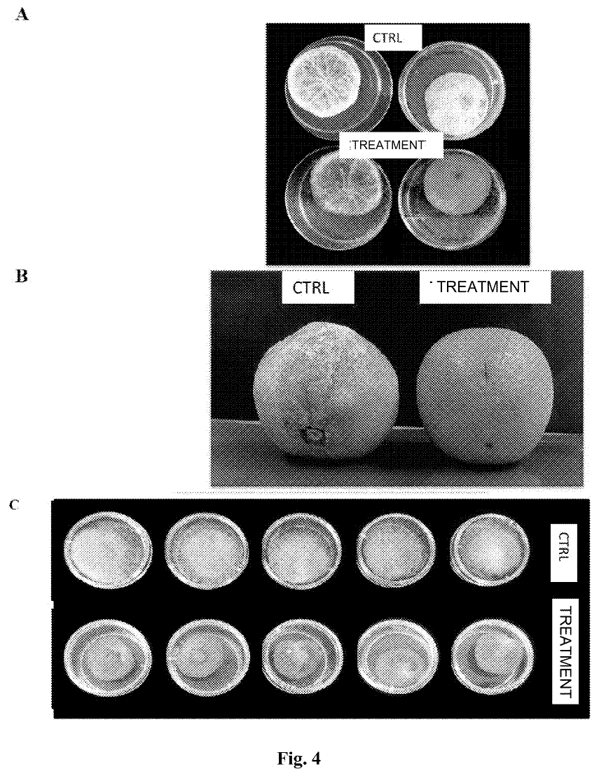

Antifungal activity can be extracted by maceration in water at leek green powder concentrations ranging from 10 to 50 g/L in order to obtain a fraction containing sufficiently concentrated active ingredients to avoid adding an additional step. Concentrations of 20 to 25 g/L are generally used to consider subsequent dilutions while maintaining a high extraction yield (of the order of 90%) (FIG. 4). The optimal maceration time to preserve antifungal activity is less than 1 hour, and preferably from 2 minutes to 30 minutes.

Maceration is usually followed by a vacuum or atmospheric pressure filtration step to remove insoluble residues and facilitate the use of the extract. Generally, it is advisable to use the extract quickly after its preparation.

### II. Materials and Methods

### 2.1 Determination of Antifungal Activity of the Dry Form

The strains used Penicillum digitatum, Fusarium oxysporum, Penicillum expansum, Alternaria alternata, Botrytis cinera and/or Trichoderma are cultured on PDA medium for 4 to 5 days at 25 or 30 °C before harvest in a 0.05% Tween solution, then adjusted to a concentration of 10⁵ spores/ml.

The leek powder is weighed and mixed with Potato Dextrose Agar (PDA) medium brought to a temperature comprised between 40 and 50 °C in order to obtain powder concentrations varying from 5 to 50 g/L. After homogenization, the mixture is placed in a Petri dish. 10 μL of spores at a concentration of 105 spores/ml are placed in the center of the Petri dish before incubation for 1 to 5 days at room temperature. The antifungal efficiency is evaluated by measuring the growth diameter using the following formula:

% growth inhibition=(Negative control diameter−Radial diameter on PDA containing leek powder) *100/Negative control diameter.

The negative control corresponds to a culture on PDA without treatment.

### 2.2 Determination of the Antifungal Activity of the Extract

a) Crystal violet quantification

The protocol implemented is adapted to phytopathogenic fungi with the ability to adhere to polystyrene surfaces, for example the Alternaria or Botrytis genera. Crystal violet interacts with protein structures and DNA and allows the correlation of the intensity of coloration with the biomass produced. The leek extract is prepared according to the method described from a powder concentration of 25 g/L.

100 μl of spores suspended in Potato Dextrose Broth (PDB) medium at a concentration of 10⁵ spores/mL are distributed in a 96-well plate and placed for 50 minutes at 25 °C. The planktonic cells are then removed by washing with 100 μL of PBS then 100 μL of PDB2X are added and mixed with 100 μL of crude or diluted extract to obtain extract percentages varying in the medium from 3.125% to 50%. The cultures are placed for 4 h 30 at 25 °C before a first observation under the microscope and quantification with crystal violet. The latter can also be set up after a 20 h incubation.

For the crystal violet quantification, a wash with 100 μL of PBS is performed and the culture is fixed with 100 μL of methanol before a 20-minute staining step with 0.5% crystal violet. The cultures are then washed extensively to remove excess crystal violet. 150 μL of a 33% acetic acid solution is added to re-solubilize the crystal violet before an absorbance measurement at 590 nm. The growth is compared to that of an untreated culture then quantified:

% growth=(Experimental point absorbance−Positive control absorbance)×100/Negative control absorbance

The negative control corresponds to a culture without treatment

The positive control corresponds to a culture containing 50% leek extract, sporicidal condition.
2.3 Post-harvest fruit treatment
Treatment with the extract

Mandarins from organic cultivation underwent surface cleaning with clear water then a 1 cm incision was made with a scalpel in the skin of the fruit before inoculating it with 3 μL of a suspension comprising 1000 spores of Penicillium digitatum in a 0.9% NaCI physiological solution. Hydrated leek green powder (50 g/L) in a carrier solution (0.9% NaCI physiological solution) or the carrier solution was introduced into the wound then the fruit was incubated at room temperature in a transparent airtight enclosure.

Halved tomato pulp was inoculated with a mixture comprising 1000 Rhizopus stolonifer spores. The spores were pre-incubated for 24h in a mixture of PDB medium and a leek white extract or carrier solution (0.9% NaCI) before being inoculated. Tomatoes were incubated in a sealed, transparent plastic container.

### ·Treatment With Powder

Mandarin orange slices 0.5 cm thick were inoculated with a suspension of Penicillium Digitatum spores in physiological solution (1000 spores/slice). Leek green powder was then spread on the surface of the sliced fruit then incubated at room temperature in a sealed, transparent plastic container.

### 2.4 Seed Treatment

Broccoli seeds were chosen for their susceptibility to both pathogens Alternaria causal agent of Alternaria and Botrytis causal agent of gray mold. Broccoli seeds are soaked for 3 minutes in a 2% bleach solution then rinsed 3 times in water. 500 μL of a solution of Alternaria or Botrytis spores at 104 spores/mL diluted in sterile water are added to approximately 70 broccoli seeds which are infected for 1h-1 h 30 at room temperature with gentle stirring. After removing the solution, 1 mL of water or extract prepared from an aqueous maceration of powder at 25 g/L is added to the broccoli seeds and left for approximately 4h at room temperature. The water or extract is removed and the seeds are placed on the surface of a Petri dish containing 1.5% agar. They are then germinated in an enclosure protected from light for 2 days then in ambient light for 5 more days. After 7 days of cultivation, the seedlings are isolated then measured (stems and roots).

### 2.5 Evaluation of the Antifungal Effects of Active Substances in Solid Medium

Lipopeptides were previously solubilized in solvents recommended by the suppliers. Briefly, surfactin and Iturin A were solubilized in absolute ethanol at 10 g/L. Fengycine was dissolved at 1 g/L in a phosphate buffer containing 0.1% DMSO. Caspofungin was solubilized at 10 g/L in distilled water. Growth control conditions were carried out in the presence of adequate amounts of solvents when necessary in order to exclude possible synergistic effects attributable thereto. Copper sulfate was dissolved in distilled water at 200 g/L.

In order to evaluate the antifungal activities of substances of interest used in combination, the different agents were pre-mixed in the following order: water, extract, SDS (if necessary), solvent (if necessary) then lipopeptide. The whole is then mixed with a nutrient agar (PDA) then deposited in 24-well cell culture plates. After solidification, the media are inoculated on the surface with 1000 Alternaria alternata spores (dissolved in a mixture of water and 0.05% Tween 80). The plates were incubated at room temperature for the various times indicated then photographed. When possible, the growth diameter of the fungus was measured. For the evaluation of the combined effects in solid medium, the concentrations of leek extract, lipopeptide and lauryl sulfate selected were subtoxic when these substances were applied individually.

### III. Results

### 3.1 Antifungal Activity of Dry Powder

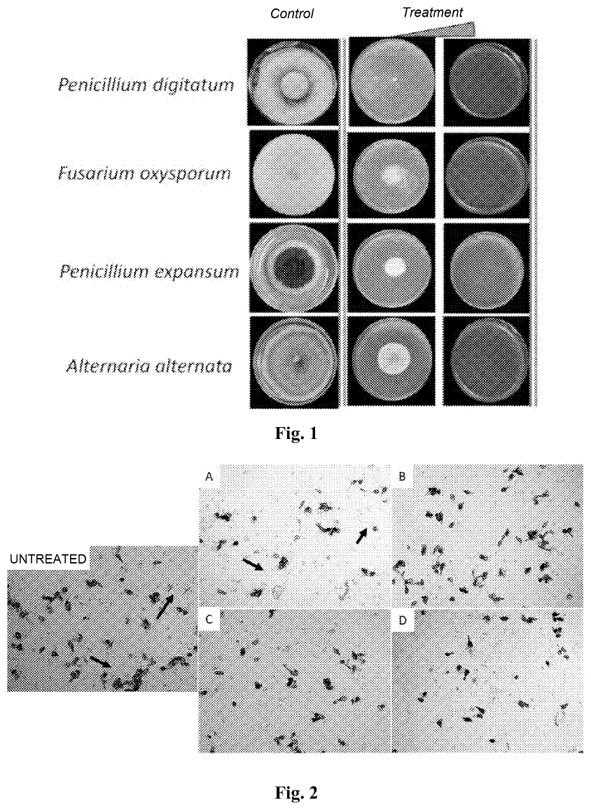

FIG. 1 shows the efficiency of the powder dispersed in an agar culture medium against Penicillium digitatum and expansum, Fusarium oxysporum and Alternaria alternata. The radial growth of molds is slowed down in the presence of 1 g/L of leek green powder (treatment) showing a different sensitivity from one phytopathogenic agent to another, it is completely inhibited from 5 g/L of powder in the agar medium.

### 3.2 Effect of Particle Size

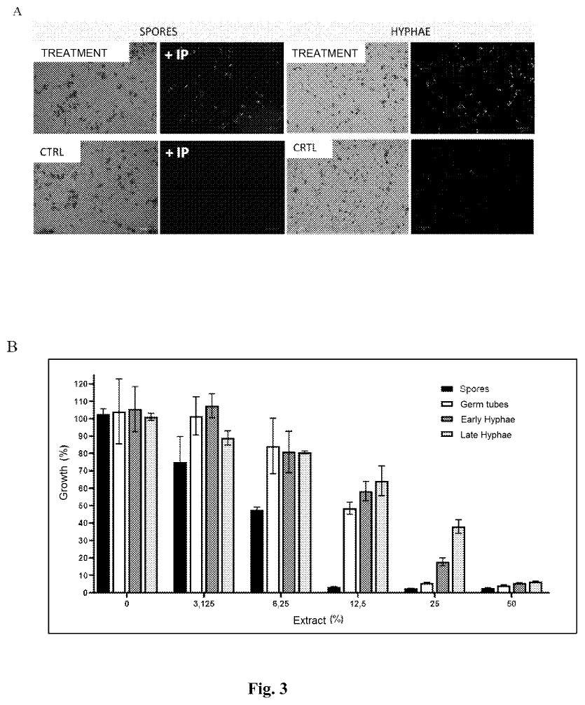

In FIG. 2, no germination of Alternaria spores is observed by optical microscopy (X20) after treatment with an extract obtained from fractions between 90 um and 700 um (images B, C, and D) while spore germination is comparable to the negative control (untreated) after treatment with an extract obtained from a dry fraction with a particle size greater than 700 um (image A). The black arrows indicate germination.

3.3 Sporicidal and fungicidal effect of the aqueous extract

FIG. 3 shows the sporicidal effect of leek extract on Alternaria alternata observed after 4 h of treatment of a culture medium containing spores, as well as a fungicidal effect obtained after initiation of hyphal elongation (FIG. 3, panel A). It should be noted that the extract has superior antifungal activity if added to the spores and that this efficiency decreases when the extract is added after germination and initiation of mold growth. FIG. 3, panel B thus shows a complete inhibition of Alternaria spore germination when 12.5% of extract is added to the culture medium, whereas at this concentration, growth is only inhibited by approximately 50% at more advanced stages of development (germ tubes, early hyphae and late hyphae). Similarly, a concentration of 25% of extract no longer allows total inhibition of growth on late hyphae. These results therefore suggest that early application of the extract is desirable to optimize its protective effect.

### 3.4 Post-harvest Fruit Treatment

FIG. 4 shows the protective effects of leek powder sprinkled on slices of clementines infected with Penicillium digitatum then left at room temperature for 4 to 5 days (see panel A). Similar observations are made if the aqueous leek extract is applied to infected clementines by introducing the spores at an incision (FIG. 4, panel B). Protection of tomatoes infected with Rhizopus stolonifer is also observed when the extract is co-applied with the spores on tomatoes (FIG. 4, panel C).
   3.5 Seed treatment

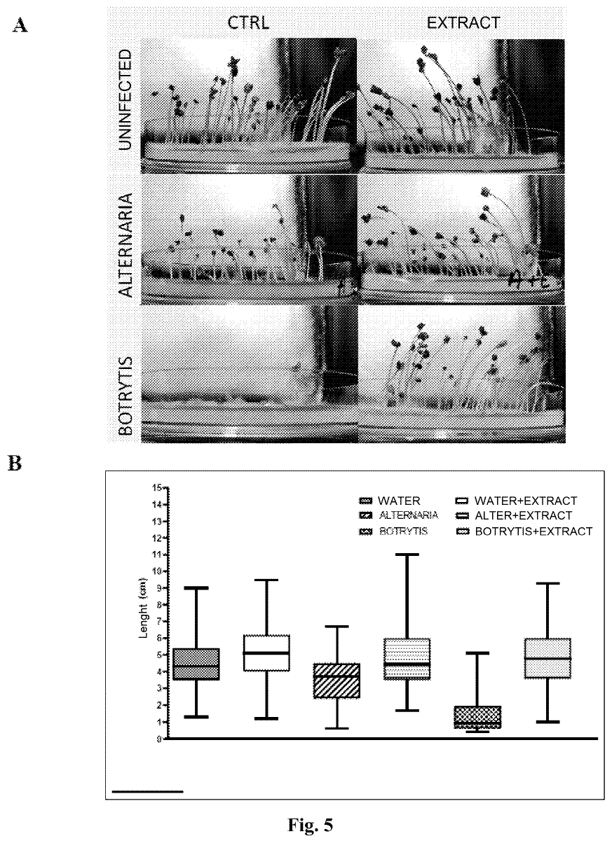

Infection of broccoli seeds by common infectious agents such as Alternaria or Botrytis cinerea, agents causing respectively Alternaria and gray mold, can be greatly limited by treatment with a leek extract prepared from 25 g/L of powder in water. FIG. 5 shows (panel A and B) the damage caused by the two infectious agents on seedling development, in particular Botrytis which greatly limits seed germination and seedling growth. A treatment of a few hours by soaking the seeds in the extract allows the seedlings to exhibit growth and seedling length distribution comparable to that of the control.

3.6 Potentiation of the antifungal effect with other products

To increase its effectiveness, the extract can be formulated in combination with different compounds that potentiate its activity. They may, for example, be substances capable of destabilizing the cell wall of molds (Fait et al., 2019; Gonçalves et al., 2017; Jahan et al., 2020). These combinations can reduce the use of biomass and/or antifungal agents used for biocontrol in agriculture.
i) Combination with detergents

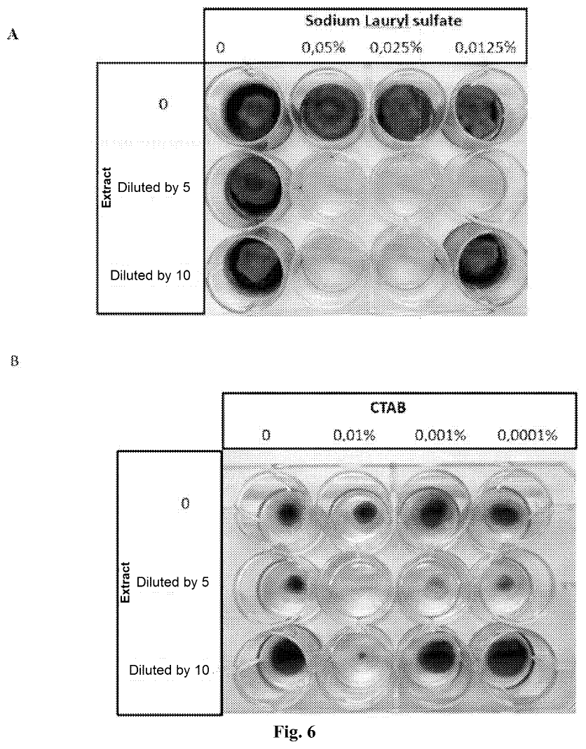

The extract can be used at reduced concentrations when combined with detergents. The latter may in particular be anionic detergents. For example, when used with 0.05% sodium lauryl sulfate, the extract concentrations required to achieve maximum antifungal activity can be reduced by 10 times compared to the concentration required to achieve the same effect by treatment using the extract alone (FIG. 6, panel A).

Cationic detergents can also be used to form effective antifungal treatment combinations with leek extract. This is the case, for example, of CTAB (cetyltrimethylammonium bromide) which, in combination with leek extract, can be used at lower doses while significantly reducing the amounts of co-product of leek biomass used (FIG. 6, panel B). The negative ecotoxic profile of CTAB can therefore be reduced thanks to the extract of the invention, in particular if the use of this detergent proves necessary for an application as a control agent.
ii) Combination with copper salts

Copper is the most widely used biocontrol treatment in agriculture. Although effective, this treatment causes environmental problems when it accumulates in soils or leaches into groundwater. The use of this product is therefore subject to strict regulatory limitations on the doses and frequencies of applications authorized in fields (execution regulation (EU) n°2018/1981 of 13/12/18). This regulation reduces the possibility of farmers using this product, which is nevertheless effective.

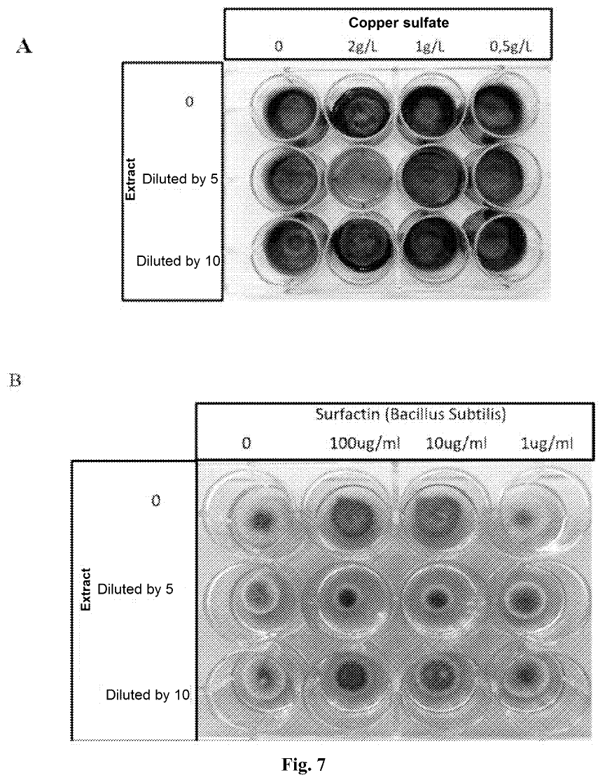

The results demonstrate that the aqueous extract of the invention can be exploited to reduce the doses of copper required to achieve a complete antifungal effect. (FIG. 7, panel A).
iii) Combination with lipopeptides

Lipopeptides are peptides with antimicrobial properties of interest for the field of biocontrol. However, their use is currently hampered by the high amounts of peptides that must be used to achieve a significant antifungal effect leading to excessive operating costs (Comont et al., 2021).

The aqueous extract of the invention can be used to potentiate the effects of lipopeptides with biocontrol properties. For example, the aqueous extract of leek powder potentiates the antifungal effects of surfactin. Surfactin used as a treatment alone at the concentrations studied does not produce any significant antifungal effect. In combination with the aqueous extract, surfactin allows an additional gain in antifungal efficiency (radial growth of the mycelium reduced by 40%) compared to the combination of the aqueous extract (FIG. 7, panel B).
iv) Combination with organic acids

The antifungal properties of organic acids such as lactic acid, acetic acid, propionic acid have been shown (Chaves et al., 2021; Hassan et al., 2015) and some of them have been added to the list of biocontrol products authorized in agriculture.

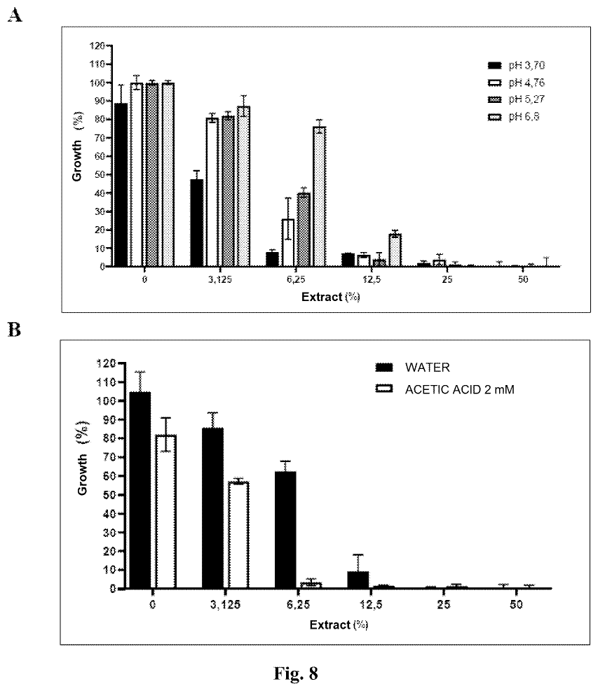

Since the antifungal effect of leek green extract is positively correlated with pH acidity (FIG. 8, panel A), the potentiation of the activity of the extract by organic acids was evaluated. It was thus shown, for example, that an extraction carried out with 0.012% (2 mM) of acetic acid allows a gain in efficiency of the extract. FIG. 8 (panel B) shows that with 6.25% of an aqueous extract prepared in 0.012% of acetic acid, no development of Alternaria spores and growth of mold is detectable after 5 hours of incubation while 12.5% of extract in the culture medium are necessary to achieve complete inhibition of germination of Alternaria spores if the extraction is carried out in water. An extraction carried out by acetic acid therefore allows to increase the effectiveness of the leek extract by a factor of at least 2.
v) Triple combination comprising leek extract, detergent and copper sulfate

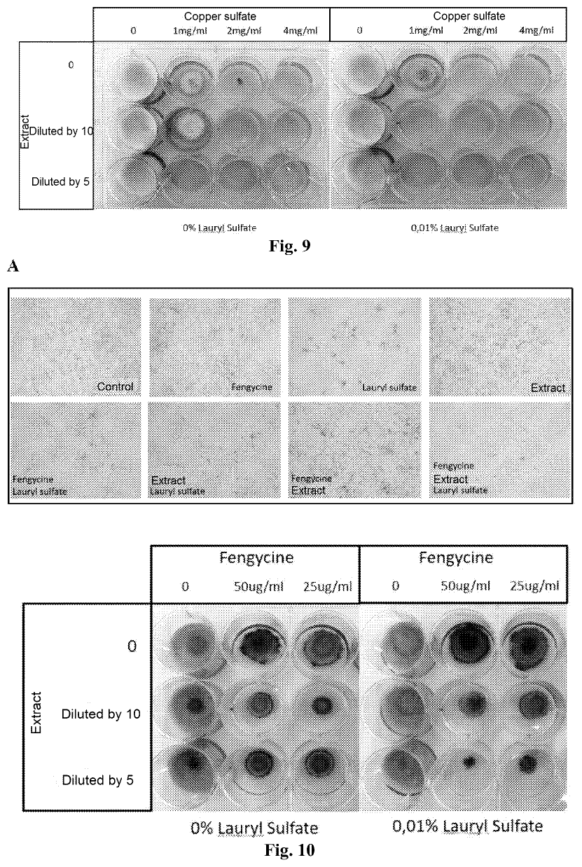

The results show a synergy of antifungal effects on A. Alternata when leek extract, detergent and copper sulfate are combined. A strong reduction in the concentration of copper sulfate required to produce this antifungal effect (FIG. 9). Indeed, no growth is observed from a copper sulfate concentration of 1 g/L when combined with 0.01% lauryl sulfate and the aqueous extract at 5 g/L or 10 g/L.
vi) Combination of leek extract, detergent and lipopeptides

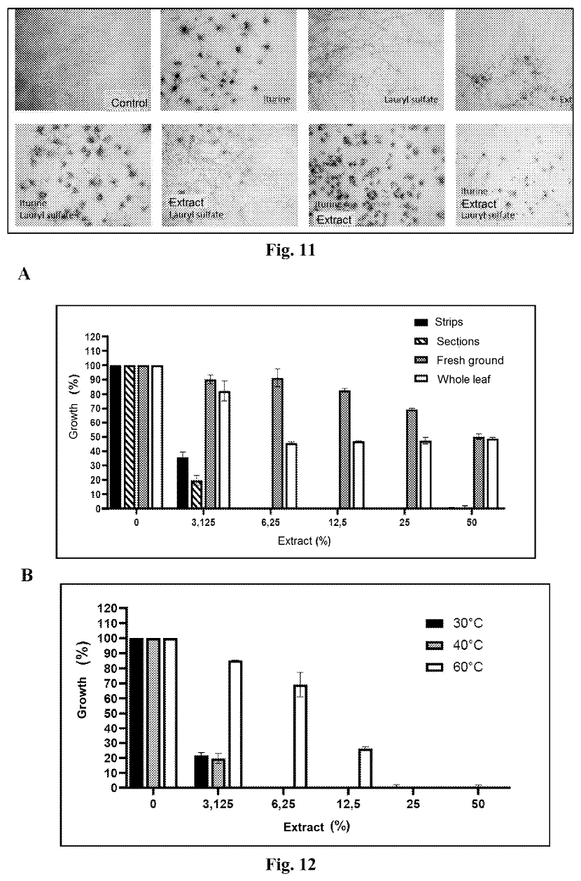

A triple combination of leek extract, detergent and lipopeptides significantly allows to reduce the concentrations of lipopeptides and extract required to produce an antifungal effect (FIGS. 10 and 11). Indeed, these substances were used at subtoxic concentrations allowing some growth of A. Alternata when tested alone, but resulted in a significant reduction in spore germination and hyphal growth when combined.

In conclusion, the aqueous extract of leek powder can be combined with biocontrol products such as copper salts or lipopeptides, detergents, particularly anionic detergents, organic acids, particularly acetic acid, allowing a gain in antifungal efficiency while reducing the doses of extract and combining agent.

### 3.6 Impact of the Transformation Method on Antifungal Activity

i) Effect of cutting and drying temperature

FIG. 12 shows the impact of the cutting step (Panel A) and the drying temperature (Panel B) on the antifungal activity evaluated by measuring the growth of the phytopathogenic mold Alternaria by quantification with crystal violet. The leek leaves are cut by the indicated approaches, then subjected to the following steps of the method (drying at 40 °C, grinding and extraction). The results show that with an extract prepared from dried strips or sections, no growth is observable from 6.25% of extract in a culture medium. When grinding fresh leaves (FIG. 12, panel A, “fresh crushed”) of leek replaces cutting, the antifungal activity decreases more than significantly, or even risks disappearing, it is only about 50% with a 50% extract, thus showing a very altered inhibitory effect. This decrease in activity could be explained by oxidation, volatilization or degradation of certain active compounds potentially associated with the intervention of specific enzymes. This type of mechanism has been previously described for organosulfur compounds or glucosinolates of alliaceae and brassicaceae (Miekus et al., 2020; Putnik et al., 2019; Sikorska-Zimny & Beneduce, 2021). An absence of cutting also leads to a notable loss of activity (50% growth observed with 50% extract prepared from whole leaves) which could result from a difficulty in drying, since the humidity level is 14% after 48 hours of drying.

Regarding the drying temperature, the results show that the antifungal activity is affected from 60 °C. For example, FIG. 12 (panel B) shows an absence of growth of Alternaria treated with an extract prepared from sections dried at 30 and 40 °C from 6.25% of extract while this inhibition is observable from 25% of extract prepared from sections dried at 60 °C. Drying at moderate temperature, such as from 30°to 50 °C, therefore leads to a humidity level of around 5% to guarantee optimal antifungal activity. Indeed, additional experiments (results not shown) have highlighted the loss of antifungal activity of leek powder stored in an environment saturated with humidity. On the contrary, storage of leek powder in a dry environment and at a humidity percentage of about 5% allows to preserve the antifungal activity for months. In particular, almost no loss of activity was noted after storage at 4 °C, 5% humidity for 36 months.
ii) Effect of leek powder concentration

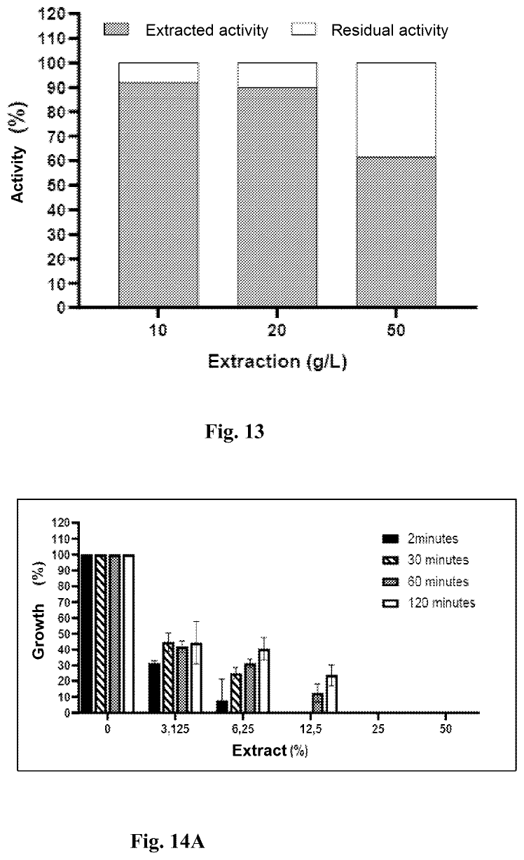

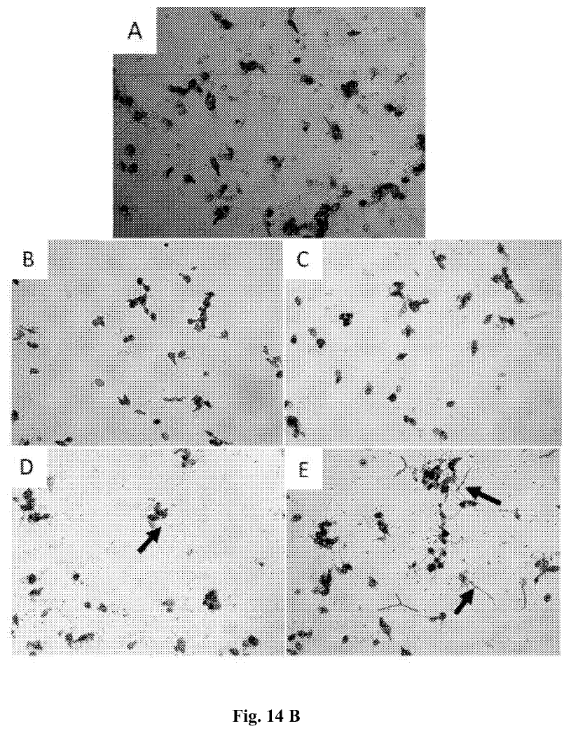

FIG. 13 shows the impact of the concentration of the extract, in particular the concentration of dry mass used for the preparation of the extract and the antifungal activity. Concentrations of 10 to 20 g of leek powder per liter of solvent show an activity of the order of 90% and are therefore preferred for producing the extract.
iii) Effect of the maceration duration of the extract

As shown in FIGS. 14A and 14B, complete inhibition of Alternaria spore germination can be observed when spores are incubated with 12.5% extract obtained after 2 to 30 min maceration of 25 g/L powder while partial germination (black arrows) is observed for prolonged maceration at 1h and 2h (FIG. 14B).

However, antifungal activity leading to complete growth inhibition is found at higher extract concentrations during 1 and 2 hour macerations (25% and 50% extract in the nutrient medium) (FIG. 14A).

1.-20. (canceled)

21. A biocontrol product comprising or consisting of a leek powder whose average particle size is equal to or less than 700 μm.

22. The biocontrol product of claim 21 wherein the powder is obtained:
from the green part of the leek, or
from the green and white parts of the leek.

23. A solution, comprising:
a leek powder whose average particle size is equal to or less than 700 μm; and
an aqueous solvent.

24. The solution of claim 23 comprising a concentration of powder per volume of aqueous solvent comprised between 5 g/L and 50 g/L.

25. The solution of claim 23, wherein the aqueous extract is a filtrate and/or includes a pH comprised between 6 and 7.

26. The solution of claim 23, the pH of which is comprised between 3.5 and 5.5, when it is acidified by adding an acid.

27. A biocontrol, insecticide or antifungal composition comprising a leek powder whose average particle size is equal to or less than 700 μm.

28. The composition of claim 27, further comprising a copper salt.

29. The composition of claim 27, further comprising at least one anionic antiseptic or disinfectant surfactant compound or a cationic surfactant.

30. The composition of claim 27, further comprising at least one lipopeptide-type compound having antimicrobial properties.

31. The composition of claim 27, further comprising an organic acid selected from acetic acid, propionic acid or mixtures thereof.

32. The composition of claim 27, comprising a combination of compounds including the cationic or anionic surfactant compound, and the copper salt or the lipopeptide.

33. A biocontrol, insecticide or antifungal composition comprising a solution, the solution comprising:
a leek powder whose average particle size is equal to or less than 700 μm; and
an aqueous solvent.

34. The composition of claim 33, further comprising a copper salt.

35. The composition of claim 33, further comprising at least one anionic antiseptic or disinfectant surfactant compound or a cationic surfactant.

36. The composition of claim 33, further comprising at least one lipopeptide-type compound having antimicrobial properties.

37. The composition of claim 33, further comprising an organic acid selected from acetic acid, propionic acid or mixtures thereof.

38. The composition of claim 33, comprising a combination of compounds including the cationic or anionic surfactant compound, and the copper salt or the lipopeptide.

39. A seed coated by film coating, soaking, contacting or spraying with the biocontrol product of claim 21.

40. A method for producing a biocontrol product comprising or consisting of a leek powder whose average particle size is equal to or less than 700 μm, the method comprising the steps of:
a) harvesting the green or green and white parts of the leek;
b) hutting the parts harvested in step a);
c) drying the parts of the leek; and
d) grinding the parts after drying to obtain an average particle size ≤700 μm.

41. The method of claim 40, comprising a further step of
e) sieving the extract obtained in step d.

42. The method of claim 40, wherein the drying step is carried out at a temperature below 70 °C; and/or for a drying time ranging from 24h to 72h, and/or until a moisture content of the order of 5% ±1% or 2% is obtained.
